(19) United States
(12) Patent Application Publication
(10) Pub. No.: US 2004/0046335 A1
(43) Pub. Date: Mar. 11, 2004

(54) Surface vehicle vertical trajectory planning

(76) Inventors: Lawrence D. Knox, Hopkinton, MA (US); Neal M. Lackritz, Southboro, MA (US); James A. Parison, New Ipswich, NH (US); William R. Short, Southboro, MA (US)

Correspondence Address: FISH & RICHARDSON PC, 225 FRANKLIN ST, BOSTON, MA, 02110, US

(21) Appl. No.: 10/368,187

(22) Filed: Feb. 18, 2003

Related U.S. Application Data
(63) Continuation-in-part of application No. 09/535,849, filed on Mar. 27, 2000, now abandoned.

(51) Int. Cl. B60G 17/00

(52) U.S. Cl. 280/5.5

(57) ABSTRACT

An active suspension system for a vehicle including elements for developing and executing a trajectory plan responsive to the path on which the vehicle is traveling. The system may include a location system for locating the vehicle, and a system for retrieving a road profile corresponding to the vehicle location.

### CLAIM OF PRIORITY

This application claims priority under 35 USC §119(e) to U.S. patent application Ser. No. 09/535,849, filed on Mar. 27, 2000, the entire contents of which are hereby incorporated by reference.

This invention relates to active vehicle suspensions, and more particularly to active vehicle suspension systems including vertical trajectory planning systems.

### BACKGROUND OF THE INVENTION

It is an important object of the invention to provide an improved active vehicle suspension.

### SUMMARY

According to one aspect of the invention, a vehicle suspension system for a surface vehicle having a payload compartment and a surface engaging device includes a controllable suspension element for applying a force between the payload compartment and the surface engaging device, and a profile storage device, for storing a plurality of profiles of paths. The profiles include vertical deflection data. The system further includes a profile retrieving microprocessor, coupled to the controllable suspension element and to the profile storage device, for retrieving from the profile storage device one of the profiles, the one profile corresponding to the path on which the vehicle is traveling.

In another aspect of the invention, in a vehicle for operating on a path, the vehicle having a payload compartment and a surface engaging device, an active vehicle suspension includes a force applying element coupling the payload compartment and the surface engaging device, for applying a force between the payload compartment and the surface engaging device to vary the vertical position of the payload compartment relative to the surface engaging device, a profile storage device for storing a vertical profile of the path, and a trajectory development subsystem, communicatingly coupled to the force applying element and to the profile storage device, for developing a trajectory plan responsive to the stored profile and for issuing commands to the force applying element, the commands corresponding to the trajectory plan

In another aspect of the invention, a method for operating an active vehicle suspension system in a surface vehicle having a data storage device includes the steps of: determining the location of the surface vehicle; determining if there is stored in the surface vehicle a vertical trajectory plan corresponding to the location; responsive to a determination that there is stored in the vehicle suspension system the vertical trajectory plan, retrieving the plan; executing the plan.

In another aspect of the invention, a method for operating an active vehicle suspension in a surface vehicle having a sensing device to sense the vertical profile of a path and a data storage device, includes the steps of sensing a vertical profile of a path; recording the profile; and comparing the recorded profile with profiles stored in a database to find if the sensed profile matches one of the stored profiles.

In another aspect of the invention, an active suspension system for a surface vehicle for operating on a path, includes an active suspension; a profile sensor for sensing a profile of the path; a path profile storage device for storing a database of path profiles; and a path profile microprocessor, coupled to the storage device and to the profile sensor, for comparing the sensed profile with the database of profiles.

In another aspect of the invention, an active suspension system for a surface vehicle includes an active suspension; a locator system for determining the location of the surface vehicle; a trajectory storage device, for storing a database of trajectories corresponding to locations; and a trajectory microprocessor for determining if the database contains a trajectory corresponding to the determined location, for retrieving the corresponding trajectory, and for transmitting to the active suspension instructions, based on the corresponding trajectory.

In another aspect of the invention, a method for determining the location of a surface vehicle includes storing a plurality of profiles of paths, the path profiles associated with locations and containing only vertical deflections of the path, measured at increments; sensing vertical deflection of a path on which the vehicle is currently traveling; and comparing the sensed vertical deflections with the path profiles.

In another aspect of the invention a method for developing a trajectory plan for a vehicle having a suspension system that includes a trajectory planning system for developing a trajectory plan and a controllable suspension element for urging a point on the vehicle to follow the trajectory plan. The method includes recording a profile comprising data points, the data points representing vertical deflections of a travel path; smoothing data of the profile, the smoothing providing positive and negative values; and recording the smoothed data as the trajectory plan.

In another aspect of the invention, an active vehicle suspension for a surface vehicle having a payload compartment and a surface engaging device and intended for operating on a path that is characterized by a profile that includes data including z-axis data includes a force applying element coupling the payload compartments and the surface engaging device. The force applying element is for applying a force between the payload compartment and the surface engaging device to control the vertical position of the payload compartment relative to the surface engaging device. The active vehicle suspension includes a trajectory developing system communicatingly coupled to the force applying element. The trajectory developing system is for developing a pre-determined path in space and for issuing command signals causing the force applying element to urge a point on the payload compartment to follow the pre-determined path in space.

In another aspect of the invention, an active vehicle suspension for a surface vehicle having a payload compartment and a surface engaging device and intended for operating on a path includes a controllable suspension element for controlling the displacement between the payload compartment and the surface engaging device responsive to vertical displacements in the path; and a trajectory developing system for issuing commands causing the controllable suspension to exert a force between the payload compartment and the surface engaging device prior to the surface engaging device encountering the vertical displacement.

In another aspect of the invention, a method for using a profile for use with a vehicle comprising a vehicle suspension including a controllable suspension element and further including sensors for sensing at least one of vertical acceleration, suspension displacement, and vertical velocity includes compiling a library of profiles, each of the profiles including a first set of data taken at intervals, the first set of data expressed in units of at least one of vertical acceleration, suspension displacement, force applied by the vehicle suspension, and vertical velocity; and driving the vehicle over a road section and recording a second set of data, the second set of data expressed in units of a corresponding at least one of vertical acceleration, suspension displacement, force applied by the vehicle suspension; and vertical velocity; and comparing the second set of data with the first set of data to determine a degree of match.

In another aspect of the invention, a method for developing an improved trajectory plan for a vehicle having a controllable suspension element includes developing, by a microprocessor, using a first set of trajectory plan parameter values, a first trajectory plan corresponding to a profile; executing the first trajectory plan, the executing including recording performance data corresponding to the first trajectory plan; modifying at least one of the values of the trajectory plan parameters to provide a modified trajectory plan parameter value; developing, using the modified trajectory plan parameter value, by the microprocessor, a second trajectory plan corresponding to the profile; executing of the second trajectory plan, the executing including recording a measure of performance data corresponding to the second trajectory plan; comparing the performance data corresponding to the executing of the first trajectory plan and the performance data corresponding to the executing of the second trajectory plan to determine the trajectory plan parameter value corresponding to the better performance data as a current trajectory plan parameter values, wherein the executing of at least one of the first trajectory plan and the second trajectory plan is a simulated executing, by the microprocessor, of the at least one of the first trajectory plan and the second trajectory plan.

In another aspect of the invention, a method for developing a trajectory plan for use by a vehicle having a payload compartment, a wheel, a plurality of sensors for measuring a corresponding plurality of states of the vehicle, and a controllable suspension element for exerting force between the wheel and the payload compartment, includes storing the trajectory plan as one of a series of commands to the controllable suspension element to exert a force, and/or a state of the vehicle as measured by at least one of the sensors.

In still another aspect of the invention, a method for operating a suspension system for a vehicle that includes a controllable suspension element, a payload compartment, a surface engaging device, a plurality of sensors, each sensor associated with one of the suspension element, the payload compartment, and the surface engaging device, includes combining a first signal and a second signal to create a feedback loop input signal, the first input signal including information reactive to states of the sensors, the second signal representing a pre-determined path in space; and inputting the feedback loop input signal to a closed negative feedback loop.

Other features, objects, and advantages will become apparent from the following detailed description, which refers to the following drawings in which:

### BRIEF DESCRIPTION OF THE SEVERAL VIEWS OF THE DRAWING

FIG. 1 is a diagrammatic view of a vehicle having a controllable suspension;

FIG. 2a is a partially block diagram, partially diagrammatic representation of a controllable suspension according to the invention;

FIG. 2b is a partially block diagram, partially diagrammatic representation of a controllable suspension according to the invention;

FIG. 3 is a diagrammatic view of the operation of a prior art active suspension;

FIGS. 4a-4c are diagrammatic views of the operation of an active suspension according to the invention;

FIG. 5 is a diagrammatic view of the operation of the operation of an active suspension according to the invention;

FIGS. 6a, 6b, and 6c are flow diagrams illustrating the operation of a suspension system according to the invention;

FIG. 7 is a diagrammatic view illustrating a method of trajectory development.

FIG. 8 is a diagram illustrating a method of collecting data in accordance with the invention;

FIG. 9 is a block diagram of a process for optimizing a trajectory plan; and

FIG. 10 is a block diagram of a feedback system of an active vehicle suspension in accordance with the invention.

### DETAILED DESCRIPTION

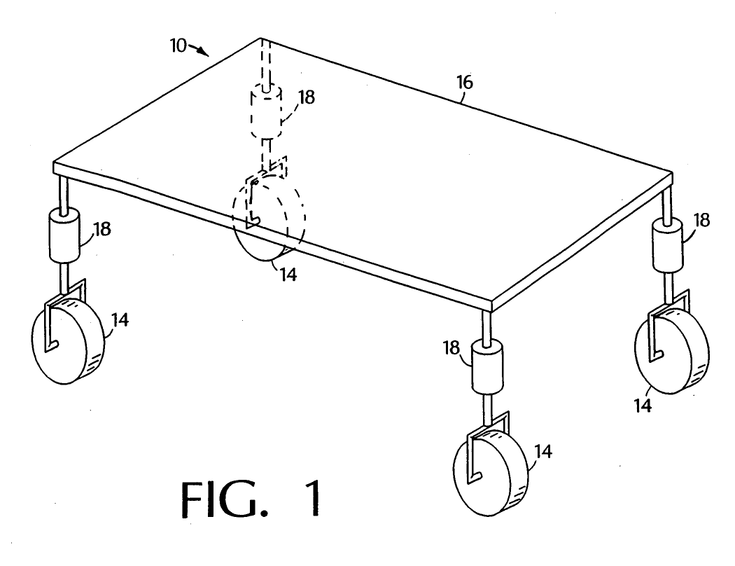

With reference now to the drawings and more particularly to FIG. 1, there is shown a diagrammatic view of a vehicle 10 according to the invention. A suspension system includes surface engaging devices, such as wheels 14 connected to payload compartment 16 (represented diagrammatically as a plane) of the vehicle by a controllable suspension element 18. In addition, the suspension system may include conventional suspension elements (not shown), such as a coil or leaf spring arrangement or damper. While one embodiment of the invention is an automobile, so that the surface engaging devices are wheels and the payload includes passengers, the invention may also be practiced in other types of vehicles, such as cargo carrying vehicles. Payload compartment 16 may be a planar structure or may be enclosed on some or all sides. The surface engaging devices may include tracks or runners. The invention may also be practiced in vehicles that engage the surface through some form of levitation, such as magnetic or pneumatic levitation, so that the surface engaging devices include devices that do not require physical contact with the surface, and so that the surface may include tracks or open terrain. For simplicity of explanation, the invention will be described as embodied in an automobile.

Controllable suspension elements 18 may be one of a variety of suspension elements that receive, or are capable of being adapted to receive, control signals from a microprocessor and to respond to the signals.

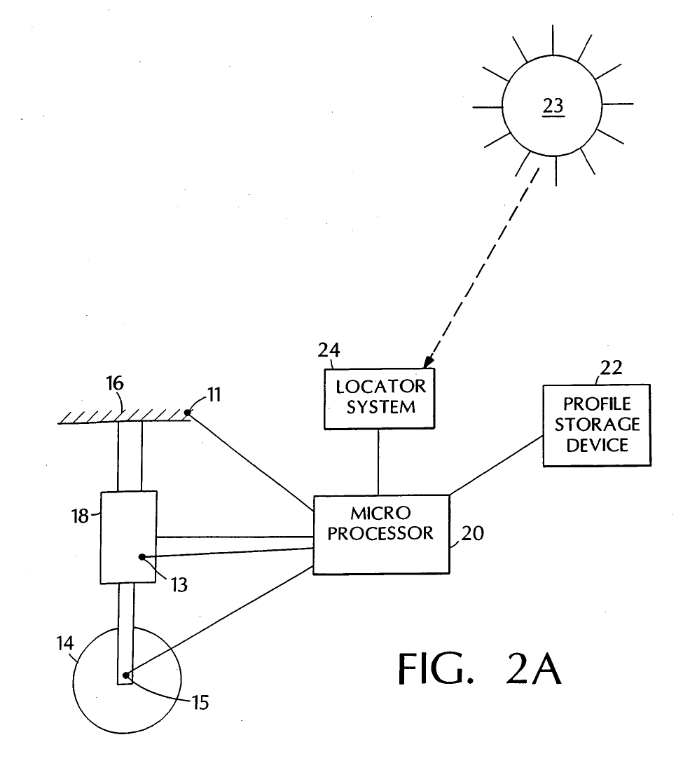

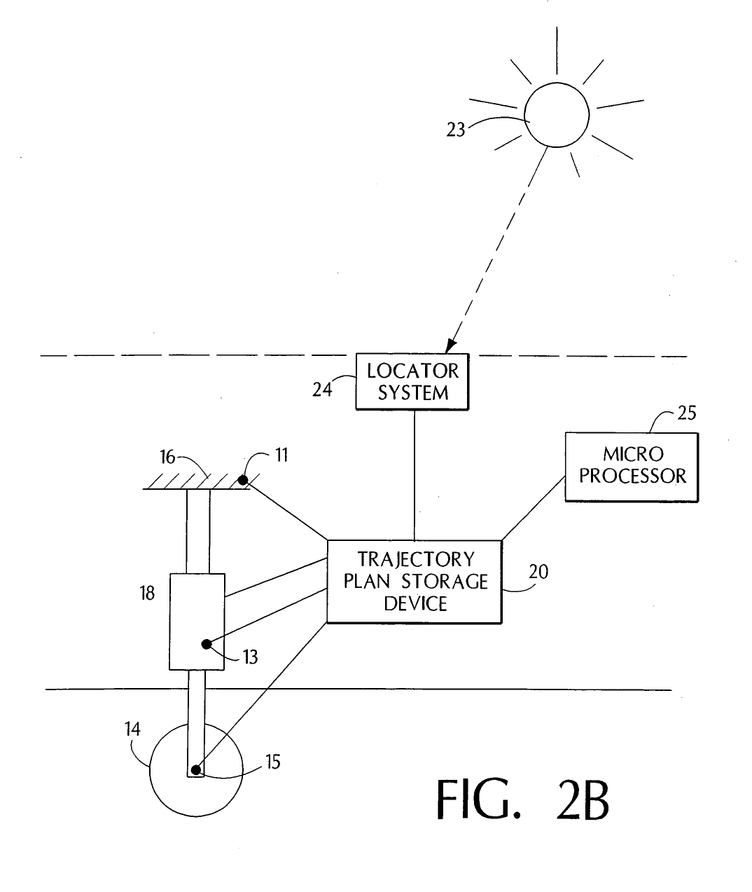

Controllable suspension elements 18 may be components of an active suspension system, in which the controllable suspension elements can respond to the control signals by varying the vertical displacement between the passenger compartment 16 and wheel 14 by applying a force. Suitable active suspension systems are described in U.S. Pat. Nos. 4,960,290 and 4,981,309 incorporated by reference herein. The force may be transmitted through some element such as a linear or rotary actuator, ball screw, pneumatic system, or hydraulic system, and may include intervening elements between the wheel and the force producing element. The controllable active suspension may also comprise an adaptive active vehicle suspension such as described in U.S. Pat. No. 5,432,700, in which signals may be used to modify adaptive parameters and gains. Controllable suspension elements 18 may also be components of a semi-active suspension system, which apply forces between passenger compartment 16 and wheel 14 reactively, in response to vertical forces resulting from wheel 14 passing over uneven surfaces. In semi-active suspension systems, the controllable suspension elements may respond to the control signals by extending or compressing a spring, by changing a damping rate, or in other ways. By way of example, the invention will be described in an embodiment in which the controllable suspension element is an active suspension element. Referring now to FIG. 2a, there is shown a block diagram of a suspension according to the invention. Controllable suspension element 18 is coupled to a microprocessor 20 which is in turn coupled to profile storage device 22 and optional locator system 24. The suspension system further includes sensors 11, 13, and 15 associated with payload compartment 16, controllable suspension elements 18, and wheels 14, respectively. Sensors, 11, 13, and 15 are coupled to microprocessor 20. Locator system 24 may receive signals from an external source, such as a positioning satellite 23. For convenience, only one of the controllable suspension elements 18 is shown. The remaining wheels 14, controllable suspension elements 18, and the respective sensors 11, 13, and 15 are coupled to microprocessor 20 substantially as shown in FIG. 2a.

Microprocessor 20 may be a single microprocessor as shown. Alternatively, the functions performed by microprocessor 20 may be performed by a number of microprocessors or equivalent devices, some of which can be located remotely from vehicle 10, and may wirelessly communicate with components of the suspension system, which are located on vehicle 10.

Profile storage device 22 may be any one of a number of types of writable memory storage, such as RAM, or mass storage devices such as a magnetic or writable optical disk. Profile storage device 22 may be included in the vehicle as shown, or may be at some remote location, with a broadcasting system for wirelessly communicating path profile data to the vehicle. Locator system 24 may be one of a number of systems for providing longitudinal and latitudinal position, such as the Global Positioning System (GPS) or an inertial navigation system (INS). Locator system 24 may include systems, which provide for user input to indicate location and may also include profile matching systems that compare the profile of the path being driven by the vehicle with the profiles stored in memory storage.

In one embodiment, the path being driven on is a roadway. However, the invention may be used in other types of vehicles that do not operate on roadways, such as open terrain vehicles and vehicles that operate on rails. The path can be typically defined by a location and a direction. By way of example, the invention will be described as embodied in an automobile for operating on a roadway.

A suspension system incorporating the invention may also include a trajectory planning subsystem, which includes (referring to FIG. 2a) microprocessor 20, profile storage device 22, and locator system 24.

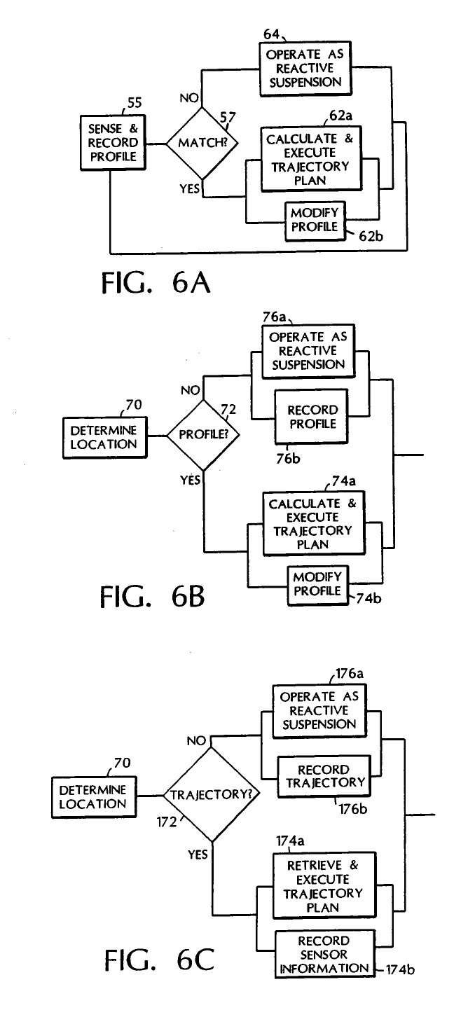

Locator system 24 detects the location of the vehicle, and microprocessor 20 retrieves a copy of the profile of the road, if available, from a plurality of profiles stored in profile storage device 22. Microprocessor 20 calculates or retrieves a trajectory plan responsive to the road profile, and issues control signals to controllable suspension element 18 to execute the trajectory plan. The profile retrieval, trajectory plan calculation, and suspension control may be performed by a single microprocessor as shown, or may be done by separate microprocessors if desired. The trajectory plan development process is described more fully in connection with FIGS. 6a and 6b. If controllable suspension element 18 is a semiactive suspension or an active suspension acting reactively to road forces, microprocessor 20 may issue an adjusted control signal to controllable suspension 16 based in part on the road profile.

In a typical form, a road profile includes a series of vertical (z-axis) displacements from a reference point. The z-axis displacement measurements are typically taken at uniform distances from the location taken in the direction of travel. A road profile can also contain additional data such as x-axis and y-axis displacement; compass heading; steering angle; or other information such as may be included in navigation systems, such as commercially available vehicle navigation products. The additional data may involve greater processing capability of microprocessor 20 and profile storage device 22, but may be advantageous in using “dead reckoning” or pattern matching techniques described below to more precisely locate the vehicle or in uniquely associating a road profile with a location. Additionally, the additional data may be advantageous in determining, for example, the degree to which traction should be considered in developing the trajectory plan.

A trajectory plan is a pre-determined path in space of a point or set of points on the payload compartment. To control the pitch of the vehicle, the trajectory may represent at least two points, respectively forward and rearward in the payload compartment. To control the roll of the vehicle, the trajectory plan may represent at least two points, one on each side of the vehicle. In a four wheeled vehicle, it may be convenient to use for trajectory plan development four points in the payload compartment, one near each wheel. Pairs of the points could be averaged (such as averaging the two points on each side of the vehicle to consider roll in the development of the trajectory plan, or averaging the two points in the front and the rear, respectively, to consider pitch in the development of the trajectory plan). For simplicity of explanation, the invention will be described in terms of a single point. The microprocessor issues control signals to controllable suspension element 18 to cause the vehicle to follow the trajectory plan. More detail on trajectory plans and the execution of trajectory plans are set forth in the examples that follow.

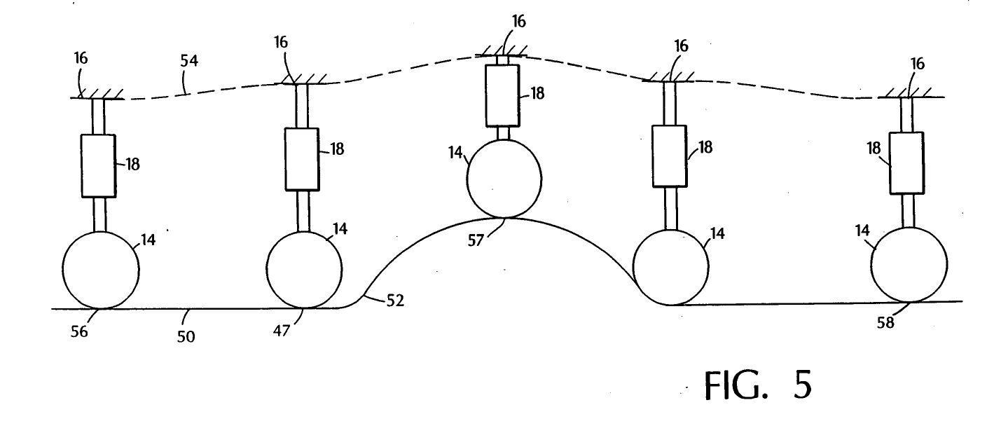

The trajectory plan may take a number of factors into account, for example matching the pitch or roll of the vehicle to the pitch or roll expected by the passengers; minimizing the vertical acceleration of the payload compartment; maximizing the stroke of the suspension available to absorb undulations in the road; minimizing the amplitude or occurrence of accelerations of an undesirable frequency, such as frequencies around 0.1 Hz, which tends to induce nausea; maximizing tire traction; or others. The trajectory plan may also include “anticipating” an undulation in the road and reacting to it before it is encountered, as will be described below in the discussion of FIG. 5. Further, particularly if the suspension system includes a conventional spring to support the weight of the car and the operation of the active suspension element extends or compresses the conventional spring, the trajectory plan may take power consumption into account.

Referring now to FIG. 2b, there is shown another embodiment of the invention incorporating a trajectory plan storage device 25. Elements of FIG. 2b are similar to elements of FIG. 2a, except profile device 22 of FIG. 2a is replaced by a trajectory plan storage device 25. Trajectory plan storage device 25 may be any one of a number of types of writable memory storage, such as RAM, or mass storage devices such as a magnetic or writable optical disk. Profile storage device 22 may be included in the vehicle as shown, or may be at some remote location, with a broadcasting system for wirelessly communicating path profile data to the vehicle.

Operation of the embodiment of FIG. 2b is similar to the operation of the embodiment of FIG. 2a, except that microprocessor 20 retrieves and calculates trajectory plans that are associated with locations rather than being associated with profiles.

Another embodiment of the invention includes both the profile storage device of FIG. 2a and the trajectory plan storage device of FIG. 2b. In an embodiment including both profile storage device 22 and trajectory plan storage device 25, the storage devices may be separate devices or may be different portions of a single memory device. Operation of embodiments including trajectory plan storage device 25 are described further in the discussion of FIG. 6c.

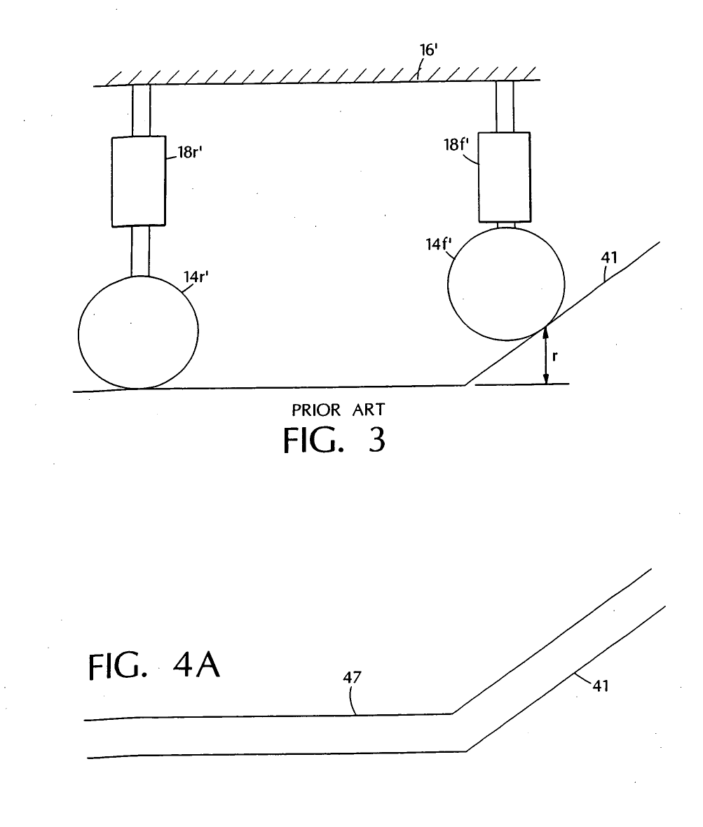

FIG. 3 shows an example of the operation of a conventional active suspension without a trajectory planning subsystem. In FIG. 3, when front wheel 14f′ encounters sloped section 41, active suspension element 18f′ exerts a force to shorten the distance between payload compartment 16′ and front wheel 14f′. When the rise r due to the slope approaches the maximum lower displacement of the suspension element, suspension element 14f′ is “nosed in” to slope 41, and in extreme cases may reach or approach a “bottomed out” condition, such that there is little or no suspension travel left to accommodate bumps in the rising surface.

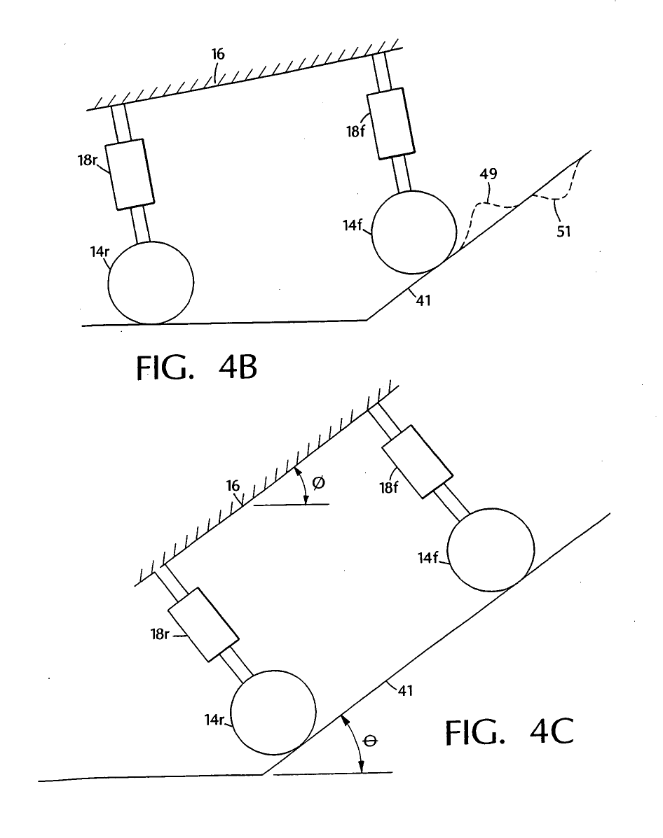

Referring now to FIGS. 4a-4c, there is shown an example of the operation of an active suspension according to the invention. Microprocessor 20 of FIG. 2a furnishes a computed trajectory plan 47, which closely matches the road surface, including sloped section 41, and issues appropriate control signals to active suspension elements 18f and 18r to follow the trajectory plan. In this example, the trajectory plan can be followed by exerting no force to shorten or lengthen the distance between wheels 14f and 14r and payload compartment 16, or if the suspension system includes a conventional spring, the trajectory plan can be followed by exerting only enough force to counteract acceleration resulting from force exerted by the spring. In FIG. 4b, when the vehicle has reached the same position in the road as in FIG. 3, payload compartment 16 is tilted slightly. In FIG. 4c, the payload compartment is tilted at an angle (p which matches the tilt θ of the road. The gradual tilt of the payload compartment to match the tilt of the road matches rider expectations. An additional advantage is that if there is a bump 49 or depression 51 in the road, the full stroke of the suspension is available to absorb the bump or depression.

The example of FIGS. 4a-4c illustrates the principle that following the trajectory plan may occur with little or no net force being applied by the controllable suspension element 18 and that execution of the trajectory planning subsystem may affect the normal operation of an active suspension. In FIGS. 4b and 4c, the vehicle is experiencing upward acceleration, and the normal operation of the active suspension operating without a trajectory plan could shorten the distance between wheel 14f and the payload compartment 16. With a trajectory plan, the active suspension would remain in a centered position, so that the vehicle payload compartment follows trajectory plan 47.

FIG. 5 shows another example of the operation of an active suspension with a trajectory planning subsystem. Road profile 50 includes a large bump 52. Microprocessor 20 (of FIG. 2a or 2b) furnishes a computed trajectory plan 54 appropriate for road profile 50. At point 56, before wheel 14 has encountered bump 52, controllable suspension element 18 exerts a force to gradually lengthen the distance between wheel 14 and payload compartment 16. As wheel 14 travels over bump 52, the normal operation of the controllable suspension element 18 causes controllable suspension element 18 to exert a force, which shortens the distance between payload compartment 16 and wheel 14. When wheel 14 reaches the crown 57 of bump 52, controllable suspension element 18 begins to exerts a force, which lengthens the distance between payload compartment 16 and wheel 14. After wheel 14 has passed the end of bump 52, controllable suspension element 18 exerts a force shortening the distance between payload compartment 16 and wheel 14. The example of FIG. 5 illustrates the principle that the trajectory planning subsystem may cause the controllable suspension element 18 to exert a force to lengthen or shorten the distance between wheel 14 and payload compartment 16 even on a level road and further illustrates the principle that the trajectory plan may cause the controllable suspension element to react to a bump or depression in the road before the bump or depression is encountered.

The example of FIG. 5 illustrates several advantages of a suspension system according to the invention. By beginning to react to bump 52 before bump 52 is encountered and by continuing to react to the bump after the bump has been passed, the vertical displacement of the payload compartment is spread over a larger distance and over a longer period of time than if the suspension system reacted to bump 52 when the tire encountered bump 52. Thus, the vertical displacement, vertical velocity and vertical acceleration of payload compartment 16 are low, so passengers encounter less discomfort than with a suspension system without trajectory planning. The trajectory planning subsystem effectively provides for large bump 52, and the normal operation of the controllable suspension element is still available to handle perturbations that are not indicated in the road profile. If the road profile has sufficient resolution to only identify large perturbations such as large bump 52, or long or substantial slopes, or if the road profile is somewhat inaccurate, the active suspension element in normal operating mode need only react to the difference between the profile and the actual road surface. For example, if the actual profile of large bump 52 is slightly different from the stored profile on which the trajectory plan is based, the active suspension system need only provide for the difference between the actual and the stored profile of bump 52. Thus, even if the profile is imperfect, the ride experienced by the passengers in the vehicle is typically better than if the suspension lacks the trajectory planning feature.

The trajectory plan may take perceptual thresholds of vehicle occupants into account. For example, in FIG. 5, even less vertical acceleration would be encountered by the occupants of the vehicle if the trajectory plan began rising before point 56 and returned the vehicle to the equilibrium position after point 58. However, the difference in vertical acceleration may not be enough to be perceived by the vehicle occupants, so the active suspension need not react before point 56 or continue to react past point 58. Additionally, if the vehicle includes a conventional suspension spring, the force applied by the active suspension between points 56 and 47 may need to exert a force to extend the spring in addition to a force to lift the vehicle, so not beginning the rise of the trajectory plan until point 56 may consume less power than beginning the rise earlier.

Referring now to FIG. 6a, there is shown a method for developing, executing, and modifying a trajectory plan by a system without optional locator system 24. At step 55, sensors 11, 13, 15 collect road profile information and transmit the information to microprocessor 20 which records the road profile in profile storage device 22. At step 58, the profile microprocessor compares the road profile information with road profiles that have been previously stored in profile storage device 22. The comparison may be accomplished using a pattern matching system as described below. If the road profile information matches a road profile that has previously been stored, at step 62a, the profile is retrieved, and microprocessor 20 calculates a trajectory plan appropriate for that profile. Concurrently, at step 62b, sensors 11, 13, 15 furnish signal representations of the road profile that may be used to modify, if necessary, the profile stored in profile storage device 22.

If it is determined at step 58 that there is no previously stored road profile that matches the road profile information collected in step 56, at step 64 controllable suspension element 18 acts as a reactionary active suspension.

Referring now to FIG. 6b, there is shown a method for developing, modifying, and executing a trajectory plan by a system that includes optional locator system 24. At step 70, locator system 24 determines the location and direction of the vehicle. At step 72 trajectory microprocessor 20 examines stored profiles in profile storage device 22 to see if there is a profile associated with that location. If there is a profile associated with that location, at step 74a microprocessor 20 retrieves the profile and calculates or retrieves a trajectory plan. Depending on how the data is stored and processed, step 72 may also consider direction of travel in addition to location in determining whether there is an associated profile. Concurrently, at step 74b, sensors 11, 13, 15 provide signals representative of the road profile that may be used to modify, if necessary, the profile stored in profile storage device 22.

If it is determined at step 72 that there is no previously stored road profile associated with that location and direction, at step 76a controllable suspension 18 acts as a reactionary active suspension. Concurrently, at step 76b, sensors 11, 13, 15 furnish signals representative of the road profile, which is stored in profile storage device 22.

Referring now to FIG. 6c, there is shown a method for developing, modifying, and executing a trajectory plan in an embodiment of the invention as shown in FIG. 2b and having some device to locate the vehicle, such as the locator system 24, or the profile storage device 22 of FIG. 2a. At step 70, locator system 24 determines the location and direction of the vehicle. At step 172 trajectory microprocessor 20 examines trajectory plans in trajectory plan storage device 25 to see if there is a trajectory plan associated with that location. If there is a profile associated with that location, at step 174a microprocessor 20 retrieves the profile and transmits the information to controllable suspension element 18, which executes the trajectory plan. Depending on how the data is stored and processed, step 172 may also consider direction of travel in addition to location in determining whether there is an associated profile. Concurrently, at step 174b, signals from sensors 11, 13, 15 representative of the actual profile may be recorded so that the trajectory plan associated with the location can later be modified to provide a smoother or more comfortable ride.

If it is determined at step 172 that there is no previously stored road profile associated with that location and direction, at step 176a controllable suspension 18 acts as a reactionary active suspension. Concurrently, at step 176b, signals representative of the trajectory resulting from the reactionary operation of the controllable suspension 18 are recorded so that the stored trajectory plan can be modified to provide a smoother or more comfortable ride.

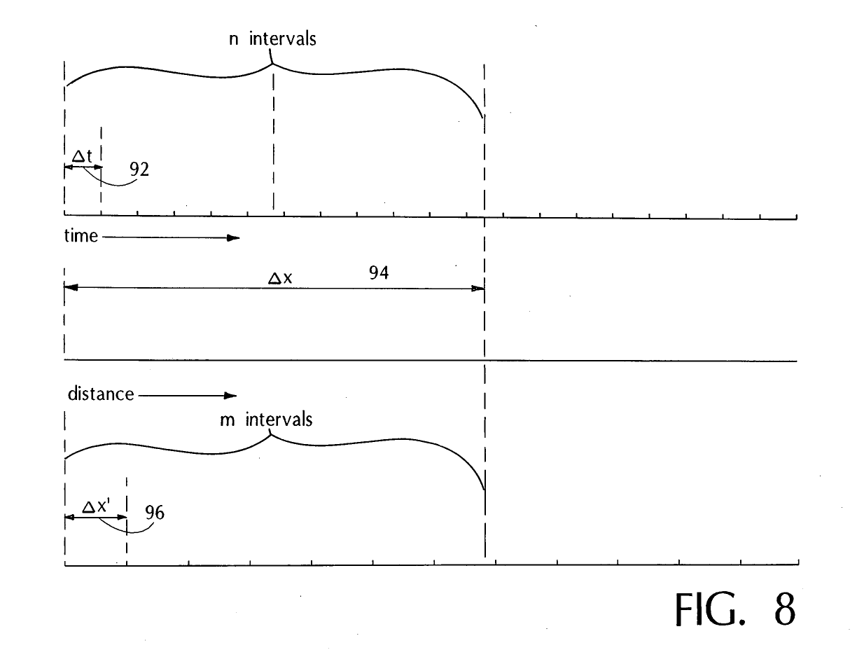

The trajectory plan may be stored in a variety of forms, as will be described below in the discussion of FIG. 8. Additionally, if the trajectory plan is calculated using parameters (such as filter break points or window widths as will be described below), the parameter may be stored, and the trajectory plan calculated “on the fly.” This method allows the system to operate with less storage, but requires more computational power.

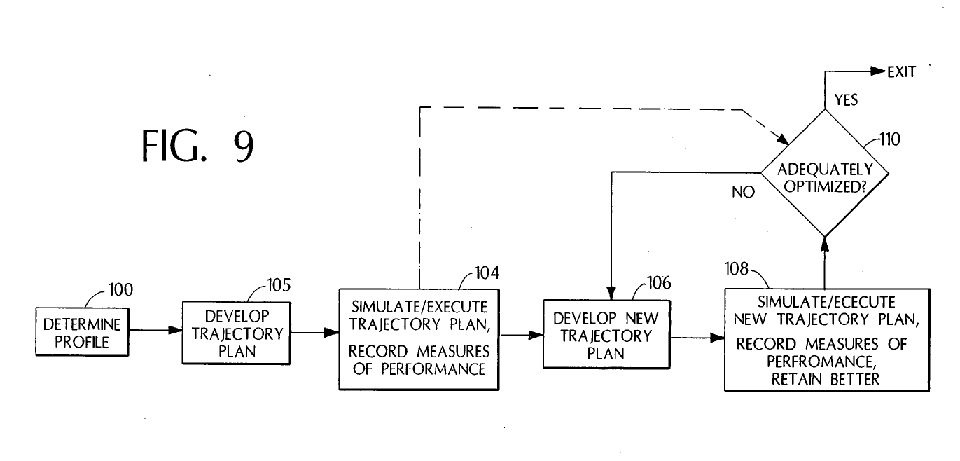

The methods of FIG. 6a, 6b, and 6c illustrate one of the learning features of the invention. Each time the vehicle is driven over a portion of road, the profile or trajectory, or both, may be modified, so that the trajectory plan furnished by microprocessor 20 may be used to provide for a smoother ride for the occupants of the vehicle during subsequent rides over the same portion of road. Additionally, the vehicle suspension system may employ an optimization process shown below in FIG. 9.

It is desirable to determine the location of the vehicle accurately, ideally within one meter, though an active suspension with a locator system having a lesser degree of precision performs better than conventional active suspensions. One method of attaining a high degree of precision is to include in locator system 24 of FIG. 2a incorporating a high precision GPS system, such as a differential system accurate to within centimeters. Another method is to include in locator system 24 of FIG. 2a a GPS system having a lower degree of precision (such as a non-differential system accurate to within about 50 meters or some other locator system not incorporating GPS) and a supplementary pattern matching system.

One pattern matching system includes a search for a known sequence of data in a target string of data. One method of pattern matching particularly useful for data that increases and decreases from a base point includes multiplying a known sequence of n numbers by strings of corresponding length in the target string. The n products are then summed, and when the strings match, the sum peaks. Supplementary or additional pattern matching techniques, such as continuous pattern matching or matching consecutive groups of n products can be used to minimize the occurrence of false matches.

This form of pattern matching can be usefully applied to a trajectory planning active suspension by recording a pattern of z-axis deflections from a base point and using the pattern of z-axis deflections as the search string. Pattern matching can then be used in at least two ways. In one application, the GPS system is used to get an approximate (within 30 meters) location of the vehicle, and pattern matching is then used to locate the vehicle more precisely, by using for the target string, the previously recorded pattern of z-axis deflections stored in profile storage device 22 of FIG. 2a. In a second application, pattern matching is used to compare the pattern of z-axis deflections as measured by sensor 15 of FIG. 2a with patterns of z-axis deflections stored in profile storage device 22 to determine if there is a profile stored in memory.

To supplement the GPS and pattern matching system, a “dead reckoning” system may also be used. In a dead reckoning system, a vehicle change in location is estimated by keeping track of the distance the vehicle travels and the direction the vehicle travels. When the vehicle has been located precisely, the distance the vehicle travels may be tracked by counting wheel rotations, and the direction of travel may be tracked by recording the wheel angle or steering angle. A dead reckoning system is very useful if GPS readings are difficult (such as if there are nearby tall buildings) and also reduces the frequency at which GPS readings need be taken.

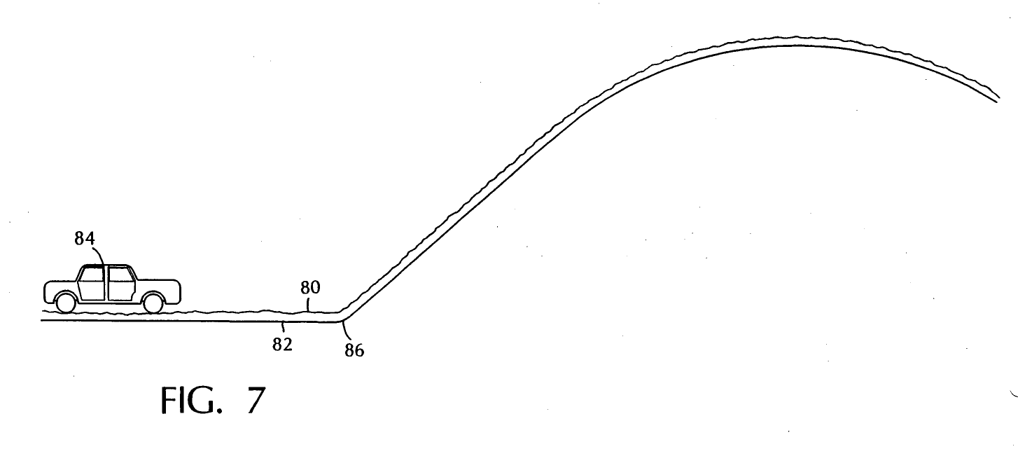

Referring now to FIG. 7, there is shown a diagrammatic view of an automobile and a road surface, illustrating the development of a trajectory plan. Line 80 represents the road profile as stored by profile device 22 of FIG. 2a. Line 82 represents the road profile 80 which has been bidirectionally low-pass filtered using a break frequency in the range of 1 Hz, and is used as the trajectory plan; the bidirectional filtering eliminates phase lag inaccuracies that may be present with single directional filtering. When the automobile 84 passes over the road surface represented by line 80, controllable suspension element 18 of FIG. 2a urges payload compartment of automobile 84 to follow the trajectory plan represented by line 82. The high frequency, low amplitude undulations in the road are easily handled by the normal operation of the active suspension. Developing of a trajectory plan by low pass filtering is very useful in dealing with the situation as described in FIGS. 3 and 4a-4c.

Processing the road profile data in the time domain to develop trajectory plans is advantageous when the velocity of the vehicle is constant; that is, each trip across the road segment is at the same velocity.

In some circumstances, processing the data in the spatial domain may be more useful than processing the data in the time domain. It may be more convenient to store data in spatial form, and processing the data in the spatial domain may make it unnecessary to transform the data to temporal form. Additionally, processing the data in the spatial domain allows the trajectory plan to be calculated including velocity as a variable; that is, the trajectory plan may vary, depending on the velocity. If the data is processed in the spatial domain, it may be advisable to perform some amount of time domain translation, for example to minimize acceleration at objectionable frequencies, such as the 0.1 Hz “seasick” frequency.

Trajectory plan development may take into account factors in addition to the spatial or time domain filtered road profile. For example, the trajectory plan may take into account large dips or bumps in the road as shown in FIG. 5, and discussed in the corresponding portion of the disclosure.

Referring to FIG. 8, there is shown a method of collecting data points that facilitates processing the data in either the time domain or the spatial domain. FIG. 8 also shows a method of converting data from the time domain to the spatial domain. Data from sensors 11, 13, 15 are collected at time internal Δt 92. A typical value for At is 0.25 ms (equivalent to a 4 kHz sampling rate). The data points taken during the interval 94 in which the vehicle has traveled distance Δx are combined and averaged. The averaged data is then processed to determine a road profile and used to calculate a trajectory plan. Typical values for Δx are four to eight inches (10.2 to 20.3 cm); Δx intervals may be measured by sensors in the vehicle drive train, which may also provide readings for the vehicle speedometer and odometer. The number n of time intervals Δt 92 taken during the interval in which the vehicle has traveled distance Δx varies with the velocity of the vehicle.

In one implementation of the invention, the averaged data points are processed to determine a profile consisting of z-axis deflections relative to time (that is, a time domain representation of the profile). Since the data from sensors 11, 13, 15 may represent displacement, velocity, or acceleration, the processing may include mathematical manipulation of some of the data to obtain z-axis deflections.

In another implementation of the invention, the time domain representation of the profile is converted to a spatial domain profile consisting of z-axis deflections relative to a spatial measure (such as distance traveled) or to a position in space by processing the time domain data points by the distance traveled or by the velocity from a reference location. A profile consisting of z-axis deflections relative to distance traveled can also be developed by collecting data in the spatial domain directly, at spatial intervals of Δx′ 96 (which if desired may further include averaging data points taken over larger spatial interval Δx 94, including m intervals of distance Δx′). A road profile that is expressed in the spatial domain is independent of the velocity of the vehicle. Representing the profile in the spatial domain may be desirable if the profile is supplemented by location information determined by GPS systems, inertial navigation systems, pattern matching, or dead reckoning, or other methods using spatial terms; if there exists a database of profiles corresponding to the location, and if the corresponding profiles are expressed in spatial terms; or if the section of road is traveled over at widely varying velocities.

In still another implementation of the invention, the profile may be recorded as a series of data points representing states of the vehicle, which are measured by sensors 11, 13, and 15. In this implementation, data from some or all of the sensors 11, 13, 15 are stored in their native dimensions (that is, accelerations and velocities are stored, respectively, as accelerations and velocities, and are not converted to displacement). The data may be averaged over time or distance, as described in the portion of the disclosure corresponding to FIG. 8. This implementation is especially useful for use with pattern matching systems, which are described above. For road profiles recorded in this implementation, pattern matching is performed by comparing the state of the vehicle as measured by sensors 11, 13, and 15 with recorded profiles (expressed as vehicle states) to determine the degree of match. Recording the profile as a series of data points also lends itself to including in the profile data in addition to states of the vehicle measured by sensors 11, 13, and 15. Additional data may include lateral acceleration, velocity, or displacement, compass heading, steering angle, or other data such as may be included in commercially available navigation systems. The additional data may be used to provide more precise pattern matching.

One method of developing a trajectory plan is to smooth the data representing the profile in a manner that provides positive and negative values. One method of smoothing is to low pass filter, preferably bi-directionally, the profile data. If the profile is expressed in spatial terms, the filter is a spatial filter; in one implementation the spatial filter is a real, one-dimensional low-pass filter having a fixed break point on the order of 15 to 30 feet (4.6 to 9.1 meters). If the profile is expressed as temporal data, filtering can be accomplished in either the time or frequency domains (temporal data can be transformed to the frequency domain through use of a Fourier transform). In other implementations, the filters could be real or complex filters of various orders or dimensions. The trajectory plan can be developed using multiple passes in each direction of the filter. While low-pass filtering of the temporal or spatial data is one method of developing a trajectory plan, other methods of smoothing profile data may be used to develop a trajectory plan. Other forms of data smoothing, such as anti-causal and non-linear filtering, averaging, windowed averaging, and others may be used to develop trajectory plans.

In one embodiment, the filter used to develop the trajectory plan has a fixed break point. In other embodiments, trajectory plans for different road sections may be developed using filters having different break points. For example, it may be advantageous to use a filter of greater length (in the spatial or time domains or lower frequency in the frequency domain) for a long, flat section of road than for an undulating section of road.

FIG. 9 shows a method for improving a trajectory plan. At step 100, a profile is determined, either by passing over the road, or by retrieving a profile from a database. At step 102, a first trajectory plan is developed using initial seed values for the trajectory plan parameter or trajectory plan parameters used in developing the trajectory plan. An example parameter may be filter length or break frequency. At step 104, there is a simulated or actual execution of the trajectory plan, and some measure (or combination of measures) of performance (such as suspension displacement, power consumption, traction, vertical velocity, or vertical acceleration of the payload compartment) recorded from the actual execution of the trajectory plan or calculated from the simulated execution of the trajectory plan. At step 106, a second trajectory plan is developed, using a different value for one or more of the trajectory plan parameters used in developing the first trajectory plan. The parameter value can be updated using any one of many known improvement techniques. At step 108, there is a simulated or actual execution of the second trajectory plan and a measure of performance recorded from the actual execution of the trajectory plan or calculated from the simulated execution of the trajectory plan. The measure or measures of performance corresponding to the actual or simulated execution of the second trajectory plan are compared to corresponding measure or measures corresponding to the first trajectory plan. The trajectory plan parameter or parameters corresponding to the better measure of performance is saved. At step 110, it is determined if an adequately improved condition exists. If an adequately improved condition exists, the improvement process is exited. If an adequately improved condition does not exist, another trajectory plan is developed, using a further updated parameter value. One example of an adequately improved condition is when a predetermined level of the measure or measures of performance is reached.

Optionally, as indicated by the dashed line, subsequent to the simulated or actual execution of the first trajectory plan at step 104, the determination of adequately improved condition step 110 may be performed. If an adequately improved condition exists, the improvement process is exited. If an adequately improved condition does not exist, another trajectory plan is developed at step 106 and the process proceeds as described above.

The specific trajectory plan parameter or parameters that can be modified depends on the method that was used to develop the trajectory plan. For example, if the trajectory plan was developed by low pass filtering the profile data, the break point of the filter may be the trajectory plan parameter that is modified; if the trajectory plan was developed using windowed averaging, the size of the window may be the trajectory plan parameter that is modified.

For example, in one implementation of the invention, the trajectory plans are developed by smoothing the profile data using a low-pass filter. Frist and second trajectory plans are developed using filters having different break points (in either the spatial or temporal domains). The initial seed value may be selected based on the smoothness of the road, using a longer (or lower frequency) break point if the road is smooth, and a shorter (or higher frequency) break point if the road is rough. An adequately improved condition may exist if neither an increase nor a decrease of the filter break point results in a better measure or measures of performance or if some pre-determined threshold of performance is reached.

The process described above is consistent with the concept of finding a local acceptable level in system performance. Known improvement techniques can be applied that may allow the system to find a global performance maximum. For example, if only a single parameter is varied, the parameter may be varied over the entire range of possible values for the parameter and performance calculated for each value. Alternatively, more sophisticated gradient-based search algorithms can be applied to improve the speed with which a maximum performance condition can be found. Gradient based methods can also be used to find maximum performance (local or global) when more than one parameter at a time is allowed to vary.

The process of FIG. 9 may be modified in a number of ways. The length of road section to which the process of FIG. 9 is applied may be varied. The process of FIG. 9 may be executed by a computer remote from the vehicle and downloaded to the vehicle. The process of FIG. 9 may be executed by a microprocessor onboard the vehicle. A single parameter may be varied over a limited range of values and the parameter corresponding to the best measure of performance retained. The process may be performed when the computational capacity of the vehicle is not being used, such as when the vehicle is parked.

As stated previously, a trajectory plan is a pre-determined path in space of a point or set of points on the payload compartment. The trajectory plan may be stored in spatial terms, or may be stored as a succession of forces to be applied by controllable suspension element 18 between payload compartment 16 and wheel 14 to cause a point, such as a point in the passenger compartment, to follow the trajectory prescribed by the trajectory plan. The trajectory plan may also be stored as a succession of vehicle states that would be measured by sensors 11, 13, 15 if the trajectory plan were executed.

Calculating and storing the trajectory plan in terms of force applied or in terms of vehicle states simplifies the calculation of the trajectory plan by eliminating mathematical manipulation of data to get the data in the proper unit of measure. For example, if the profile is expressed in terms of force applied by the controllable suspension, the profile data can be low-pass filtered to obtain a trajectory plan that is also expressed in terms of force applied by the controllable suspension. The need for converting the data from force to acceleration to velocity to displacement is eliminated.

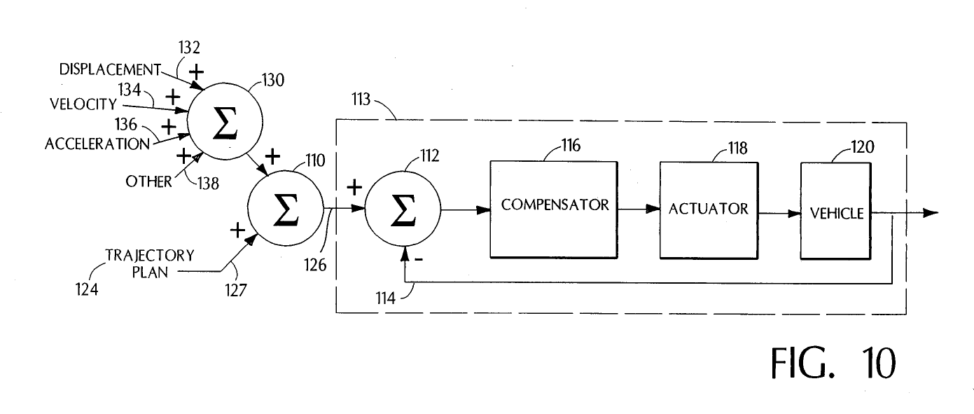

FIGS. 3, 4a-4c, and the corresponding portions of the disclosure illustrated the principle that the execution of the trajectory planning subsystem may affect the normal reactive operation of the active suspension. In FIG. 3, a normal reactive operation of the suspension element may cause the vehicle to “nose in” to a hill. In FIGS. 4a-4c, the controllable suspension using a trajectory plan causes the vehicle to follow a pre-determined path in space (that is, the trajectory plan) and pitch, rather than “nosing in” to a hill. A suspension system that causes the reactive operation of the suspension element to follow a trajectory plan may be better understood by referring to FIG. 10, below.

FIG. 10 shows a block diagram of a feedback control system representing a controllable suspension system that urges a vehicle payload compartment to follow a trajectory described by a trajectory plan according to the invention. A first input combiner 130 combines signals 132, 134, 136, 138 that represent desired states as detected by the various sensors such as 11, 13, and 15. States represented by signals 132, 134, 136, and 138 typically include values of displacements 132 (for example of the controllable suspension), velocities 134 (for example vertical velocity of the payload compartment), accelerations or forces 136 (for example vertical acceleration of the payload compartment or force applied to result in the vertical acceleration of the payload compartment), or the values 138 of other variables (for example, horizontal acceleration or velocity, tire traction, roll or pitch, or available suspension travel). Signals 132, 134, 136, 138 may require a modifier, such as an integrator to convert the states represented by signals 132, 134, 136, 138 to a different domain (for example temporal, frequency, or spatial domains) or a different unit of measure. Summer 130 outputs vehicle condition signal 125. Vehicle condition signal 125 represents a signal that could be used in a feedback control loop in a conventional active suspension that does not use a trajectory plan.

Vehicle condition signal 125 is then combined additively at summer 110 with a signal 127 representative of a trajectory plan to generate a closed loop input signal 126 to a reactive closed path feedback control loop 113. Trajectory plan signal 127 is a pre-determined path in space related to the profile of the road on which the vehicle is traveling. The trajectory plan signal 127 may need to be modified, by changing its domain or by converting it to a different unit of measure. Calculating and storing the trajectory plan signal in the same domain or unit of measure as vehicle condition signal 125 may reduce or eliminate the need for modifying the trajectory plan 127 to change its domain or to convert it to a different unit of measure.

Reactive closed path feedback control loop 113 operates as a conventional active suspension using a negative feedback loop. At summer 112, a feedback signal on feedback path 114 is combined subtractively with the closed loop input signal 126 to generate an error signal to compensator 116. The compensator amplifies the signal by a gain typically referred to as G and generates a command to the actuator 118, which applies a force to the vehicle 120. The resulting effect on the vehicle is fed back to summer 112 along feedback path 114.

Vehicle condition signal 125 may include a signal 136 representing zero vertical acceleration, or a signal 134 representing zero vertical velocity, or a signal representing no pitch. Trajectory plan input 124 may represent a trajectory plan such as the trajectory plan 47 of FIG. 4a or the trajectory plan 54 of FIG. 5. If vehicle condition signal 125 represents a zero value, the closed path feedback loop input signal 126 represents the trajectory plan 47 of FIG. 4a or 54 of FIG. 5, and the reactive closed feedback loop 113 acts to urge the payload compartment to follow the trajectory plan 47 or 54.

The vehicle condition signal 125 may also include a signal representing a nonzero value for some desired state. For example, the suspension system may be designed so that vehicle condition signal 125 includes a signal that provides some roll during high-speed turns to provide sensory feedback to the driver. In that case, the trajectory plan signal (which, in the case of roll, would include paths in space of at least two points, one on each side of the vehicle) could combine with vehicle condition signal 125 so that feedback loop input signal 126 includes an amount of roll that could be different than the amount of roll in both vehicle condition signal 125 and trajectory plan signal 127. The amount of roll in trajectory plan signal 127 may also be zero, in which case the amount of roll in feedback loop input signal 126 would include the same amount of roll as in vehicle condition signal 125; or the amount of roll in trajectory plan signal 127 could be equal and opposite to the amount of roll in vehicle condition signal 125, in which case the feedback loop input signal 126 would include zero roll.

A suspension system according to the invention is advantageous over active suspension systems that use various methods to adjust the gain G of a feedback loop because it provides a greater degree of passenger comfort without compromising other performance factors. For example, the full available suspension travel can be utilized without making the suspension “harsher.”

There has been described novel apparatus and techniques for vertical trajectory planning. It is evident that those skilled in the art may now make numerous modifications and uses of and departures from the specified apparatus and techniques disclosed herein. Consequently, the invention is to be construed as embracing each and every novel feature and novel combination of features present in or possessed by the apparatus and techniques disclosed herein and limited only by the spirit and scope of the appended claims.

What is claimed is:

1. A vehicle suspension system for a surface vehicle having a payload compartment and a surface engaging device, comprising:
a controllable suspension element for applying a force between said payload compartment and said surface engaging device;
a profile storage device for storing a plurality of profiles of paths,
said profiles including vertical deflection data; and
a profile retrieving microprocessor coupled to said controllable suspension element and to said profile storage device for retrieving from said profile storage device one of said profiles,
said one profile corresponding to the path on which said vehicle is traveling.

2. A vehicle suspension system in accordance with claim 1, wherein said profile storage device is located remotely from said surface vehicle.

3. A vehicle suspension system in accordance with claim 1, wherein said profile retrieving microprocessor is located remotely form said surface vehicle.

4. A vehicle suspension system in accordance with claim 1 and further comprising,
a locator system, coupled to said microprocessor for determining the location of said surface vehicle,
wherein said microprocessor is adapted to determine if there is stored in said profile storage device a profile corresponding to said location.

5. A vehicle suspension system in accordance with claim 1 and further comprising,
a sensor for acquiring vertical deflection data.

6. A vehicle suspension system in accordance with claim 5, wherein said microprocessor is adapted to compare said vertical deflection data with said stored profiles.

7. A vehicle suspension system in accordance with claim 5, wherein said microprocessor is adapted to modify said profile and to store said modified profile in said profile storage device.

8. A vehicle suspension system in accordance with claim 1 and further comprising,
a trajectory developing microprocessor for developing a trajectory plan corresponding to said retrieved profile.

9. A vehicle suspension system in accordance with claim 8 and further comprising,
a control processor for issuing command signals to said controllable suspension element to execute said trajectory plan.

10. An active vehicle suspension for a surface vehicle having a payload compartment and a surface engaging device, said vehicle for operating on a path, said suspension comprising:
a force applying element coupling said payload compartment and said surface engaging device for applying a force between said payload compartment and said surface engaging device to vary the vertical position of said payload compartment relative to said surface engaging device;
a profile storage device for storing a vertical profile of said path; and
a trajectory development subsystem communicatingly coupled to said force applying element and to said profile storage device for developing a trajectory plan responsive to said stored vertical profile and for issuing command signals to said force applying element,
said command signals corresponding to said trajectory plan.

11. An active vehicle suspension in accordance with claim 10, wherein said profile storage device is located remotely from said surface vehicle.

12. An active vehicle suspension in accordance with claim 10, wherein said trajectory development subsystem is located remotely from said surface vehicle.

13. A method for operating an active vehicle suspension system in a surface vehicle having a data storage device comprising:
determining the location of said surface vehicle;
determining if there is stored in said surface vehicle a vertical trajectory plan corresponding to said location;
retrieving said plan in response to a determination that there is stored in said vehicle suspension system said vertical trajectory plan, and executing said plan.

14. A method for operating an active vehicle suspension in accordance with claim 13 and further comprising,
recording input signals from performance sensors;
modifying said vertical trajectory plan in response to the performance sensor input signals.

15. A method for operating an active suspension in accordance with claim 13, wherein said determining includes the use of a global positioning satellite.

16. A method for operating an active vehicle suspension in a surface vehicle having a sensing device to sense the vertical profile of a path and a data storage device comprising:
sensing a vertical profile of a path;
recording said profile; and
comparing said recorded profile with profiles stored in a database to find if said sensed profile matches one of said stored profiles.

17. A method for operating an active vehicle suspension in accordance with claim 16 and further comprising,
retrieving, responsive to a finding that a sensed profile matches one of said stored profiles, a trajectory plan associated with said one stored profile; and
executing said trajectory plan.

18. A method for operating an active vehicle suspension in accordance with claim 17 and further comprising,
recording input signals from performance sensors;
modifying said vertical trajectory plan in response to the performance sensor input signals.

19. A method for operating an active vehicle suspension in accordance with claim 16 and further comprising,
responsive to a finding that said sensed profile matches one of said stored profiles, developing a trajectory plan for said sensed profile; and
executing said trajectory plan.

20. An active suspension system for a surface vehicle for operating on a path, comprising;
an active suspension;
a profile sensor for sensing a profile of said path;
road profile storage device for storing a database of path profiles; and
a path profile microprocessor coupled to said storage device and to said profile sensor for comparing said sensed profile with said database of path profiles.

21. An active suspension system in accordance with claim 20,
wherein said road profile storage device is located remotely from said surface vehicle.

22. An active suspension system in accordance with claim 20,
wherein said road profile microprocessor is located remotely from said surface vehicle.

23. An active suspension system in accordance with claim 20 and further comprising,
a trajectory storage device for storing a database of trajectories, said trajectories corresponding to said road profiles;
a trajectory microprocessor coupled to said storage device and to said road profile microprocessor and responsive to said road profile microprocessor for retrieving one of said trajectories and for communicating instruction signals based on said one of said trajectories to said active suspension.

24. An active suspension system in accordance with claim 23, wherein said trajectory storage device is located remotely from said surface vehicle.

25. An active suspension system in accordance with claim 23., wherein said trajectory microprocessor is located remotely from said surface vehicle.

26. An active suspension system in accordance with claim 20 and further comprising,
a trajectory development microprocessor coupled to said active suspension for developing a vertical trajectory for said sensed profile.

27. An active suspension system for a surface vehicle comprising:
an active suspension;
a locator system for determining the location of said surface vehicle;
a trajectory storage device, for storing a database of trajectories corresponding to locations; and
a trajectory microprocessor for determining if said database contains a trajectory corresponding to said determined location, for retrieving corresponding trajectory, and for transmitting to said active suspension instruction signals based on said corresponding trajectory.

28. An active suspension in accordance with claim 27, wherein said locator system comprises a global positioning system device.

29. A method for operating an active vehicle suspension system in a surface vehicle having a data storage device, comprising,
determining the location of said surface vehicle;
determining if there is stored in said surface vehicle a profile corresponding to said location;
retrieving said profile in response to a determination that there is stored in said vehicle suspension system said profile,
developing a trajectory plan in response to said retrieved profile, and
executing said trajectory plan.

30. A method for operating an active vehicle suspension in accordance with claim 29 and further comprising,
modifying said profile; and
storing said modified profile in said storage device.

31. A method for determining the location of a surface vehicle comprising:
storing a plurality of profiles of paths,
said path profiles associated with locations and containing only vertical deflections of said path from a predetermined reference plane measured at increments;
sensing vertical deflection of a path on which said vehicle is currently traveling from the predetermined reference plane; and
comparing said sensed vertical deflections with said path profiles.

32. For use with a vehicle having a suspension system, said vehicle suspension system comprising a trajectory planning system for developing a trajectory plan, a controllable suspension element for urging a point on said vehicle to follow said trajectory plan, a method for said developing of said trajectory plan, comprising:
recording a profile comprising data points, said data points representing vertical deflections of a travel path;
smoothing data points of said profile to create smoothed data, said smoothing providing positive and negative values; and
recording said smoothed data as said trajectory plan.

33. An active vehicle suspension for a surface vehicle having a payload compartment and a surface engaging device, said vehicle for operating on a path, said path being characterized by a profile, said profile including profile data including z-axis data, said suspension comprising:
a force applying element coupling said payload compartment and said surface engaging device for applying a force between said payload compartment and said surface engaging device to control the vertical position of said payload compartment relative to said surface engaging device;
a trajectory developing system communicatingly coupled to said force applying element, said trajectory developing system for developing a predetermined path in space and for issuing command signals causing said force applying element to urge a point on said payload compartment to follow said predetermined path in space.

34. An active vehicle suspension in accordance with claim 33, said trajectory developing system comprising a smoothing device for smoothing said profile data to develop said predetermined path in space.

35. An active vehicle suspension in accordance with claim 34, wherein said smoothing device comprises a low-pass filter.

36. An active vehicle suspension in accordance with claim 35, wherein said smoothing device comprises a bi-directional low pass filter.

37. An active vehicle suspension for a surface vehicle having a payload compartment and a surface engaging device, constructed and arranged for operating on a path, said suspension comprising:
a controllable suspension element constructed and arranged for controlling the displacement between said payload compartment and said surface engaging device and responsive to vertical displacements in said path; and
a trajectory developing system constructed and arranged for issuing command signals to said controllable suspension representative of expected vertical displacement in said path to exert a force between said payload compartment and said surface engaging device prior to said surface engaging device encountering an expected vertical displacement to reduce the vertical displacement of said payload compartment when moving on said path.

38. A method for developing a trajectory plan in accordance with claim 37, wherein said smoothing device comprises a low pass filter.

39. A method for developing a trajectory plan in accordance with claim 38, wherein said low pass filter is bi-directional.

40. A method for developing a trajectory plan in accordance with claim 39, wherein said bi-directional filtering is constructed and arranged to make multiple passes.

41. A method for developing a trajectory plan in accordance with claim 37, wherein said profile data points represent said vertical deflections measured with respect to time.

42. A method for developing a trajectory plan in accordance with claim 37, wherein said profile data points represent vertical deflections measured with respect to distance traveled.

43. For use with a vehicle comprising a vehicle suspension including a controllable suspension element and further including sensors for sensing at least one of vertical acceleration, suspension displacement, and vertical velocity, a method for using a profile, comprising:
compiling a library of profiles, each of said profiles including a first set of data taken at intervals, said first set of data expressed in units of at least one of vertical acceleration, suspension displacement, force applied by said vehicle suspension, and vertical velocity; and
driving said vehicle over a road section and recording a second set of data, said second set of data expressed in units of a corresponding at least one of vertical acceleration, suspension displacement, force applied by said vehicle suspension, and vertical velocity; and
comparing said second set of data with said first set of data to determine a degree of match.

44. A method for using a profile in accordance with claim 4, further comprising:
if said comparing indicates a high degree of match, determining if there exists a better trajectory plan corresponding to the pattern of said second set of data, said better trajectory plan executable by said controllable suspension element; and
if said determining indicates that a better trajectory plan exists, retrieving and executing said better trajectory plan.

45. A method for using a profile in accordance with claim 44, further comprising:
if said determining indicates that a better trajectory plan does not exist, creating said better trajectory plan using said second set of data.

46. A method for using a profile in accordance with claim 44, further comprising:
if said comparing does not indicate a high degree of match, storing said second set of data.

47. A method for using a profile in accordance with claim 44 further comprising the step of, if said comparing does not indicate a high degree of match, calculating a trajectory plan corresponding to said second set of data points.

48. A method for using a profile in accordance with claim 4, wherein said first set of data points include states of said vehicle measured by said sensors, said data points expressed as at least one of accelerations and velocities.

49. A method for developing an improved trajectory plan for a vehicle having a controllable suspension element, comprising:
developing, by a microprocessor, using a first set of trajectory plan parameter values, a first trajectory plan corresponding to a profile;
executing said first trajectory plan, said executing including recording performance data corresponding to said first trajectory plan;
modifying at least one of said values of said trajectory plan parameters to provide a modified trajectory plan parameter value;
developing, using said modified trajectory plan parameter value, by said microprocessor, a second trajectory plan corresponding to said profile;
executing of said second trajectory plan, said executing including recording a measure of performance data corresponding to said second trajectory plan;
comparing said performance data corresponding to said executing of said first trajectory plan and said performance data corresponding to said executing of said second trajectory plan to determine the trajectory plan parameter value corresponding to the better performance data; and
retaining the set of trajectory plan parameter value corresponding to the better performance data as a current trajectory plan parameter value,
wherein said executing of at least one of said first trajectory plan and said second trajectory plan is a simulated executing, by said microprocessor, of said at least one of said first trajectory plan and said second trajectory plan.

50. A method for developing an improved trajectory plan in accordance with claim 49, further comprising:
subsequent to said execution of said first trajectory plan, comparing said performance data with a predetermined threshold performance value;
in the event that said performance data is at least said predetermined threshold performance value, exiting the process; and
in the event that said performance data is not at least said predetermined threshold performance value, performing said modifying step.

51. A method for developing an improved trajectory plan in accordance with claim 49, further comprising:
a second modifying of said one of said values of said trajectory plan parameters to provide a second modified trajectory plan parameter value;
a developing, using said modified trajectory plan parameter value, by said microprocessor, of a third trajectory plan corresponding to said profile;
executing of said third trajectory plan, said executing including recording a measure of performance data corresponding to said third trajectory plan, wherein said executing is one of an actual executing of said second trajectory plan and a simulated executing of said second trajectory plan by said microprocessor and wherein said measure of performance data is one of an actual measured performance and a calculated measure of performance calculated from said simulated executing of said third trajectory plan;
comparing said performance data corresponding to said executing of said current trajectory plan and said performance data corresponding to said executing of said third trajectory plan to determine the trajectory plan parameter value corresponding to the better performance data; and
retaining the trajectory plan parameter value corresponding to the better performance data as said current trajectory plan value.

52. A method for developing a trajectory plan in accordance with claim 5, wherein said microprocessor is in a computer remote from said vehicle and further including the steps of
downloading said trajectory plan from said computer to said vehicle.

53. A method for developing a trajectory plan in accordance with claim 5, wherein said microprocessor is on-board said vehicle.

54. A method for developing a trajectory plan in accordance with claim 5, wherein said at least one of said values is a filter break frequency.

55. A method for developing a trajectory plan for use by a vehicle having a payload compartment, a wheel, a plurality of sensors for measuring a corresponding plurality of states of said vehicle, and a controllable suspension element for exerting force between said wheel and said payload compartment, comprising:
storing said trajectory plan as one of
a series of commands causing said controllable suspension element to exert a force, and
a state of said vehicle as measured by at least one of said sensors.

56. A method for operating a suspension system for a vehicle, said vehicle comprising a controllable suspension element, a payload compartment, a surface engaging device, a plurality of sensors, each sensor associated with one of said suspension element, said payload compartment, and said engaging device, said method comprising:
combining a first signal and a second signal to create a feedback loop input signal, said first input signal including information reactive to states of said sensors, said second signal representing a predetermined path in space; and
inputting said feedback loop input signal to a closed negative feedback loop.

57. A method for operating a suspension system in accordance with claim 56, wherein said closed negative feedback loop has a gain and wherein said gain is constant.
